(19) United States
(12) Patent Application Publication
(10) Pub. No.: US 2002/0030434 A1
(43) Pub. Date: Mar. 14, 2002

(54) Plasma display

(75) Inventors: Shigeo Mikoshiba, Tokyo (JP); Keiji Ono, Tsukuba-shi (JP); Susumu Miyazaki, Kitasoma-gun (JP)

Correspondence Address: SUGHRUE MION ZINN MACPEAK & SEAS, PLLC, 2100 Pennsylvania Avenue, NW, Washington, DC, 20037-3213, US

(73) Assignee: SUMITOMO CHEMICAL COMPANY, LIMITED

(21) Appl. No.: 09/935,577

(22) Filed: Aug. 24, 2001

(30) Foreign Application Priority Data
Sep. 8, 2000 (JP) 2000-272864

(51) Int. Cl. H01J 1/62

(52) U.S. Cl. 313/485; 313/484

(57) ABSTRACT

Vacuum ultraviolet radiation excited light-emitting devices each exhibiting a high luminance are provided. A vacuum ultraviolet radiation excited light-emitting device includes a discharge space filled with a rare gas between front and rear faceplates disposed parallel with each other, and a fluorescent material layer provided on the front faceplate, the fluorescent material layer having a thickness of not more than about 7 μm.

### FIELD OF THE INVENTION

The present invention relates to vacuum ultraviolet radiation excited light-emitting devices which are excited to emit light by vacuum ultraviolet radiation and, more particularly, to a plasma display panel (hereinafter sometimes referred to as “PDP”) used as a flat panel display having a large-sized screen, and a rare gas lamp.

### BACKGROUND OF THE INVENTION

The PDP as one example of the vacuum ultraviolet radiation excited light-emitting device is a flat panel display realizing upsizing of screen, which is difficult with a cathode ray tube (CRT) or a liquid crystal color display, and is expected to be used as a display installed in a public space or for a TV set having a large screen.

Generally, PDPs have a structure described in Japanese Patent Laid-Open No. 10-142781. A pair of glass substrates are disposed generally parallel with each other, and the space between the glass substrates is partitioned with partition walls to provide a multiple discharge spaces (each hereinafter sometimes referred to as “cell”) filled with a rare gas composed of Ne or Xe as a major component. Of the glass substrates, one positioned on the PDP viewer side is a front faceplate, while the other a rear faceplate. On the side of the front faceplate facing the rear faceplate are formed electrodes, a dielectric layer covering the electrodes, and a protective layer (MgO layer) on the dielectric layer.

Address electrodes crossing the electrodes formed on the front faceplate are formed on the side of the rear faceplate facing the front faceplate, and a fluorescent material layer is formed so that the rear faceplate and wall surfaces of the partition walls is covered with the fluorescent material layer. When AC voltage is applied across the electrodes to cause electrical discharge, vacuum ultraviolet radiation produced by the electric discharge causes the fluorescent material to emit light. The viewer of the PDP views visible light passing through the front faceplate.

Besides the PDP, the rare gas lamp is also a vacuum ultraviolet radiation excited light-emitting device. The rare gas lamp is similar in structure to the PDP except that the discharge space thereof is usually not partitioned with a multiplicity of partition walls. Attention is focused on the rare gas lamp from the viewpoints of environment because the rare gas lamp does not include mercury.

Conventional vacuum ultraviolet radiation excited light-emitting devices represented by the PDP and the rare gas lamp generally have a fluorescent material layer on the rear faceplate side in the structure described above. However, there is still a desire for development of a vacuum ultraviolet radiation excited light-emitting device exhibiting a higher luminance than the conventional vacuum ultraviolet radiation excited light-emitting devices.

### SUMMARY OF THE INVENTION

The inventors of the present invention have made intensive study in order to develop a vacuum ultraviolet radiation excited light-emitting device having a higher luminance. As a result, they have found that a vacuum ultraviolet radiation excited light-emitting device including a fluorescent material layer having a thickness equal to or smaller than a specific value formed on the front faceplate exhibits a high luminance. Thus, the present invention has been completed.

Accordingly, the present invention provides a vacuum ultraviolet radiation excited light-emitting device comprising a discharge space filled with a rare gas between a front faceplate and a rear faceplate, and a fluorescent material layer provided on the front faceplate, the fluorescent material layer having a thickness of not more than about 7 μm. The present invention also provides a vacuum ultraviolet radiation excited light-emitting device in which a fluorescent material contained in the fluorescent material layer has an average primary particle diameter of not more than 1 μm.

### DETAILED DESCRIPTION OF THE INVENTION

Hereinafter, the present invention will be described in more detail.

In the vacuum ultraviolet radiation excited light-emitting device according to the present invention, the fluorescent material layer is provided on the front faceplate. In this case light emitted from the fluorescent material layer passes through the fluorescent material layer itself and is viewed by the viewer. For this reason, if the fluorescent material layer on the front faceplate is too thick, the amount of emitted light decreases when the light passes through the fluorescent material layer. Specifically, if the thickness of the fluorescent material layer on the front faceplate is more than 7 μm, the amount of emitted light decreases when the light passes through the fluorescent material layer. Therefore, the thickness of the fluorescent material layer is not more than 7 μm. From the viewpoint of a higher luminance, the fluorescent material layer preferably has a smaller thickness, more preferably not more than 5 μm.

In a typical PDP, electrodes are formed on the side of the front faceplate facing the rear faceplate, a dielectric layer covers the electrodes, and a protective film (MgO film) on the dielectric layer is formed. In the vacuum ultraviolet radiation excited light-emitting device of the present invention, the fluorescent material layer may be further formed on the protective film or, alternatively, between the dielectric layer and the protective film.

If fluorescent material layers are provided on both the front faceplate and the rear faceplate, respectively, the luminance of the vacuum ultraviolet radiation excited light-emitting device can be enhanced further.

In the case where the vacuum ultraviolet radiation excited light-emitting device is a rare gas lamp, the rear faceplate is preferably provided with a fluorescent: material layer having a thickness of not less than about 30 μm because such a rare gas lamp exhibits a further enhanced luminance.

Alternatively, in the case where the vacuum ultraviolet radiation excited light-emitting device is a PDP, the fluorescent material layer on the rear faceplate preferably has a thickness of not more than about 20 μm, more preferably not more than about 10 μm. If the fluorescent material layer on the rear faceplate is too thick, the discharge space in a cell becomes narrow, resulting in a lower luminance undesirably.

Processes for forming a fluorescent material layer on the front faceplate or the rear faceplate include a screen printing process using a fluorescent material paste.

A binder resin for use in such a fluorescent material paste used in the fluorescent material layer forming process may be any one of binder resins known in the art. Examples of such known binder resins include ethyl cellulose, methyl cellulose, nitrocellulose, acetyl cellulose, acetylethyl cellulose, cellulose propionate, hydroxypropyl cellulose, butyl cellulose, and benzyl cellulose.

Examples of organic solvents for use in the fluorescent material paste include diethylene glycol monomethyl ether, diethylene glycol monoethyl ether, diethylene glycol monobutyl ether, diethylene glycol monomethyl ether acetate, diethylene glycol monoethyl ether acetate, ethylene glycol monomethyl ether acetate, ethylene glycol monobutyl ether acetate, propylene glycol monobutyl ether, dipropylene glycol, dipropylene glycol monomethyl ether, dipropylene glycol monoethyl ether, dipropylene glycol monomethyl ether acetate, propylene glycol monomethyl ether acetate, 3-methyl-3-methoxybutanol, butylcarbitol acetate, methoxybutyl acetate, and terpineol.

The higher the light-transmissivity of the fluorescent material applied to the front faceplate, the more the luminance of the vacuum ultraviolet radiation excited light-emitting device is enhanced. If the average primary particle diameter of the fluorescent material is equal to or smaller than the wavelength of visible light, the fluorescent material allows visible light to pass therethrough. The fluorescent material preferably has an average primary particle diameter of not more than 1 iM, more preferably not more than 0.5 μm, most preferably not more than 0.3 μm for a higher transmissivity of light emitted from itself.

In the present invention, the thickness of the fluorescent material layer on the front faceplate is not more than 7 μm. Since each particle of the fluorescent material needs to be considerably smaller than the thickness of the fluorescent material layer, use of fluorescent material powder having the foregoing average primary particle diameter is preferable also for the formation of the fluorescent material layer having a thickness of not more than 7 μm.

As the fluorescent material, there can be used any one of conventionally known fluorescent materials, examples of which include Y₂O₃:Eu, Y₂O₂S:Eu, and (Y, Gd)BO₃:Eu as red fluorescent materials; BaAl₁₂O₁₉:Mn, BaMgAl₁₀O₁₇:Mn, BaMgAl₁₄O₂₃:Mn, and Zn₂SiO₄:Mn as green fluorescent materials; and BaMgAl₁₀O₁₇:Eu and BaMgAl₁₄O₂₃:Eu as blue fluorescent materials.

The provision of the fluorescent material layer having a thickness of not more than 7 μm makes it possible to realize a vacuum ultraviolet radiation excited light-emitting device, such as a rare gas lamp or a PDP, exhibiting a high luminance.

### EXAMPLES

Hereinafter, the present invention will be described more specifically by way of examples, which should not be construed to limit the scope of the present invention.

### Example 1

0.0081 mol of yttrium chloride hexahydrate (YCl₃.6H₂O), 0.0009 mol of europium chloride hexahydrate (EuCl₃.6H₂O) and 0.45 mol of urea were added to 900 ml of pure water, and the resulting mixture was adjusted to pH 2.5 by hydrochloric acid and then allowed to stand for 24 hours. This aqueous solution was heated at 92° C. for one hour to produce a slurry, which in turn was subjected to centrifugation to give a fluorescent material precursor having an average primary particle diameter of 0.15 μm measured by TEM observation. The fluorescent material precursor thus given was calcined at 1200° C. for one hour in atmospheric air, to afford a fluorescent material (Y₂O₃:Eu) having an average primary particle diameter of 0.14 μm.

The fluorescent material thus obtained was applied onto front faceplate glass. The thickness of the resulting fluorescent material layer was 5 μm. Electrodes were formed on rear faceplate glass and a dielectric layer was formed over the electrodes. Further, the dielectric layer was covered with a fluorescent material layer having a thickness of 15 μm, which in turn was covered with a protective layer, thus providing a rear faceplate. The front faceplate and rear faceplate thus obtained were bonded together so as to define a discharge space, thereby completing a PDP. The luminance of light emission of the PDP thus obtained was 180 cd/m².

### Comparative Example 1

A PDP was manufactured in completely the same manner as in EXAMPLE 1 except that the fluorescent material was not applied onto the front faceplate glass. The luminance of light emission of the PDP thus obtained was 150 cd/m².

### Comparative Example 2

A PDP was manufactured in completely the same manner as in EXAMPLE 1 except that the thickness of the resulting fluorescent material layer onto the front face plate glass was 10 μm. The luminance of light emission of the PDP thus obtained was 160 cd/m².

The present invention makes it possible to realize a vacuum ultraviolet radiation excited light-emitting device exhibiting a high luminance and hence is very useful in industry.

What is claimed is:

1. A vacuum ultraviolet radiation excited light-emitting device comprising a discharge space filled with a rare gas between a front faceplate and a rear faceplate, and a fluorescent material layer provided on the front faceplate, the fluorescent material layer having a thickness of not more than about 7 μm.

2. The vacuum ultraviolet radiation excited light-emitting device according to claim 1, further comprising a fluorescent material layer on the rear faceplate.

3. The vacuum ultraviolet radiation excited light-emitting device according to claim 2, which is a rare gas lamp.

4. The vacuum ultraviolet radiation excited light-emitting device according to claim 3, wherein the fluorescent material layer on the rear faceplate has a thickness of not less than about 30 μm.

5. The vacuum ultraviolet radiation excited light-emitting device according to claim 2, which is a plasma display panel.

6. The vacuum ultraviolet radiation excited light-emitting device according to claim 5, wherein the fluorescent material layer on the rear faceplate has a thickness of not more than about 20 μm.

7. The vacuum ultraviolet radiation excited light-emitting device according to claim 1, wherein the fluorescent material layer contains a fluorescent material having an average primary particle diameter of not more than about 1 μm.
